(19) United States
(12) Patent Application Publication
(10) Pub. No.: US 2006/0049751 A1
(43) Pub. Date: Mar. 9, 2006

(54) Display device with dual display areas

(76) Inventors: Jiun-Haw Lee, Taipei (TW); Tien Rong Lu, Tainan City (TW); Jie-Farn Wu, Miaoli (TW); Yih Chang, Jhonghe City (TW)

Correspondence Address: BIRCH STEWART KOLASCH & BIRCH, PO BOX 747, FALLS CHURCH, VA, 22040-0747, US

(21) Appl. No.: 10/934,575

(22) Filed: Sep. 7, 2004

(51) Int. Cl. H05B 33/00; H01J 1/62

(52) U.S. Cl. 313/506

(57) ABSTRACT

A display device with dual display areas comprises a transparent substrate, a semi-reflecting layer, a first display area and a second display area. The transparent substrate has a first surface and a second surface, which is opposite to the first surface. The semi-reflecting layer is disposed on the first surface or on the second surface. The first display area comprises, in sequence, a first electrode, at least one first organic functional layer and a second electrode. The first electrode is disposed over the first surface of the transparent substrate. The second display area comprises, in sequence, a third electrode, at least one second organic functional layer and a fourth electrode. The third electrode is disposed over the first surface of the transparent substrate. The thickness of the fourth electrode is larger than the thickness of the second electrode.

### BACKGROUND OF THE INVENTION

1. Field of Invention

This invention relates to a display device and, in particular, to a display device with dual display areas.

2. Related Art

The present electronic devices have become more compact and lightweight, so the flat-panel displays thereof accordingly become more important. In addition, the electronic devices comprise various applications, wherein the electronic devices with dual display areas for displaying plentiful image information are one of the major features of the new generation electronic products. For example, the mobile phone may include a display device with dual display areas, which can be used as a main-display panel and a sub-display panel, respectively.

The conventional display device with dual display areas is manufactured by attaching two display panels, each of which has a single display area, such as an LCD panel or an organic electroluminescent (OEL) panel. With reference to FIG. 1, a conventional display device with dual display areas 3 includes a first display panel 31 and a second display panel 32. Wherein the first display panel 31 includes a transparent substrate 311, a first electrode 312, a light-emitting area 313, a second electrode 314, and a cover plate 315. The light-emitting area 313 is sandwiched between the first electrode 312 and the second electrode 314. The first electrode 312 is disposed on the transparent substrate 311, and the cover plate 315 is attached to the transparent substrate 311 with an adhesive. In addition, the second display panel 32 includes a transparent substrate 321, a third electrode 322, a light-emitting area 323, a fourth electrode 324, and a cover plate 325. The light-emitting area 323 is sandwiched between the first electrode 322 and the second electrode 324. The first electrode 322 is disposed on the transparent substrate 321, and the cover plate 325 is attached to the transparent substrate 321 with an adhesive. In this case, the cover plate 315 of the first display panel 31 is opposite to and attached to the cover plate 325 of the second display panel 32 so as to form the conventional display device with dual display areas 3.

As mentioned above, since the conventional display device with dual display areas includes two cover plates and two transparent substrates, the whole display device has larger size, thickness, and heavier weight, which can not match the trend towards the electronic device with more compact and lightweight. However, when utilizing one display panel with single display area, the multiple displaying orientations may not be carried out. Moreover, the demand for providing divided displaying screens may also not be performed.

It is therefore a subjective of the invention to provide a display device with dual display areas, which can solve the above-mentioned problems.

### SUMMARY OF THE INVENTION

In view of the foregoing, the invention is to provide a compact and lightweight display device with dual display areas.

To achieve the above, a display device with dual display areas of the invention comprises a transparent substrate, a semi-reflecting layer, a first display area and a second display area. In this invention, the transparent substrate has a first surface and a second surface, which is opposite to the first surface. The semi-reflecting layer is disposed on the first surface or on the second surface. The first display area comprises, in sequence, a first electrode, at least one first organic functional layer and a second electrode. The first electrode is disposed over the first surface of the transparent substrate. The second display area comprises, in sequence, a third electrode, at least one second organic functional layer and a fourth electrode. The third electrode is disposed over the first surface of the transparent substrate. The thickness of the fourth electrode is larger than the thickness of the second electrode.

To achieve the above, a display device with dual display areas of the invention comprises a transparent substrate, a semi-reflecting layer, a first display area and a second display area. In this invention, the transparent substrate has a first surface and a second surface, which is opposite to the first surface. The semi-reflecting layer is disposed on the first surface or on the second surface. The first display area comprises, in sequence, a first electrode, at least one first organic functional layer and a second electrode. The first electrode is disposed over the first surface of the transparent substrate. The second display area comprises, in sequence, a third electrode, at least one second organic functional layer and a fourth electrode. The third electrode is disposed over the first surface of the transparent substrate.

As mentioned above, the display device with dual display areas of the invention has two display areas disposed on a single transparent substrate, and the directions of light emitted from the display areas can be controlled by the thicknesses of the semi-reflecting layer, the second electrode and the fourth electrode. Comparing with the prior art, the display device with dual display areas of the invention saves one transparent substrate and one cover plate, so the thickness of the whole device is more compact and more lightweight. Moreover, since both the display areas can be formed in the same manufacturing processes, the fabrication time can be shortened, the cost of the display device can be decreased, and the production yield can be increased. In addition, the two display areas can show different image information according to any requirement. Of course, the display areas can display the same image information. Furthermore, the two display areas may combine to present an extended screen, which can overcome the limitation of the size of a single display area. In the invention, when the display areas emit light, the display device possesses the function of displaying image; otherwise, when the display areas do not emit light, the display device possesses the function of mirror. In summary, the display device of the invention has not only the function of dual directions displaying but also the function of mirror. Moreover, the display device of the invention is compact and lightweight, and has the features of the manufacturing process integration and information division. Therefore, the invention is suitable for mass production.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing the conventional display device with dual display areas;

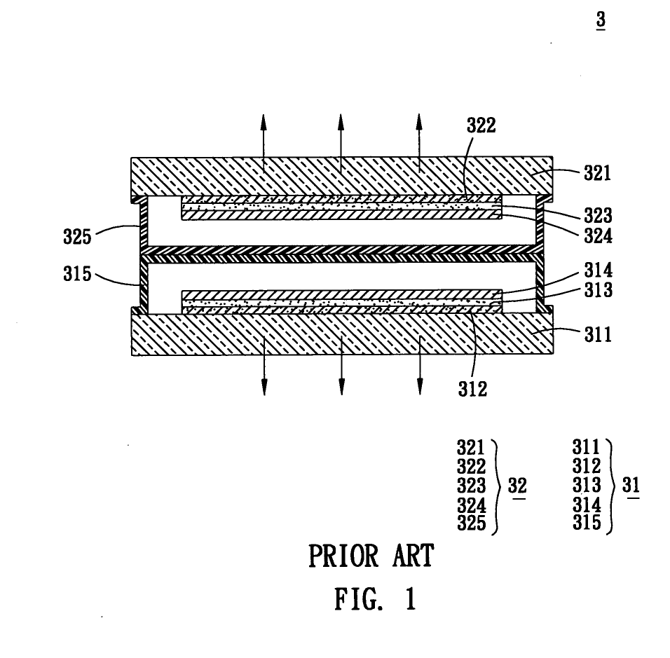

FIGS. 2A and 2B are schematic views showing a display device with dual display areas according to a first embodiment of the invention;

FIGS. 3A and 3B are schematic views showing an application of the display device shown in FIG. 2A;

FIGS. 4A and 4B are schematic views showing a display device with dual display areas according to a second embodiment of the invention;

FIGS. 5A and 5B are schematic views showing another display device with dual display areas according to the second embodiment of the invention; and

FIGS. 6A and 6B are schematic views showing an application of the display device shown in FIG. 5A.

### DETAILED DESCRIPTION OF THE INVENTION

The present invention will be apparent from the following detailed description, which proceeds with reference to the accompanying drawings, wherein the same references relate to the same elements.

### First Embodiment

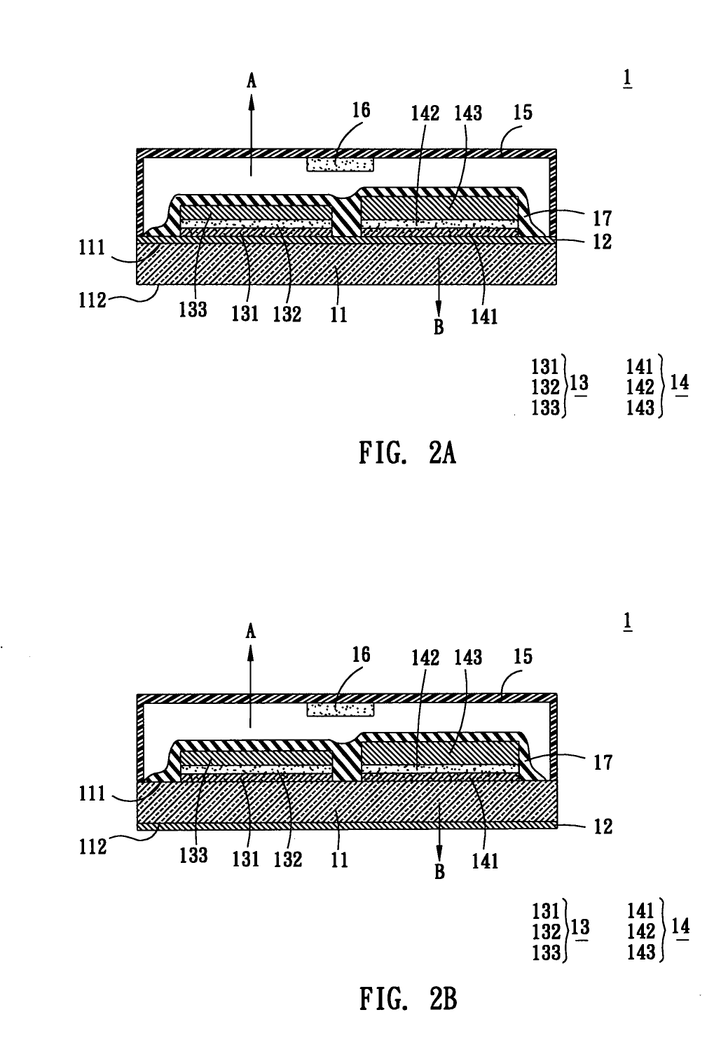

With reference to FIGS. 2A and 2B, a display device with dual display areas 1 according to the first embodiment of the invention comprises a transparent substrate 11, a semi-reflecting layer 12, a first display area 13 and a second display area 14. In the embodiment, the transparent substrate 11 has a first surface 111 and a second surface 112, which is opposite to the first surface 111. The semi-reflecting layer 12 is disposed on the first surface 111 or on the second surface 112. The first display area 13 comprises, in sequence, a first electrode 131, at least one first organic functional layer 132 and a second electrode 133. The first electrode 131 is disposed over the first surface 111 of the transparent substrate 11. The second display area 14 comprises, in sequence, a third electrode 141, at least one second organic functional layer 142 and a fourth electrode 143. The third electrode 141 is disposed over the first surface 111 of the transparent substrate 11. The thickness of the fourth electrode 143 is larger than the thickness of the second electrode 133.

In the present embodiment, the transparent substrate 11 can be a flexible or a rigid substrate. The transparent substrate 11 can also be a plastic or glass substrate. In particular, the flexible substrate or plastic substrate can be made of polycarbonate (PC), polyester (PET), cyclic olefin copolymer (COC), or metallocene-based cyclic olefin copolymer (mCOC).

As shown in FIG. 2A, the semi-reflecting layer 12 is disposed on the first surface 111 of the transparent substrate 11. Herein, the semi-reflecting layer 12 can be formed on the first surface 111 by evaporating, sputtering, or ion plating. The semi-reflecting layer 12 is made of a metal or dielectric material, and has an optical transmittance between about 10% and 90%.

In the embodiment, when the semi-reflecting layer 12 is made of a metal, an insulating layer 13 (not shown) is further disposed between the semi-reflecting layer 12 and the first and third electrodes 131 and 141. The insulating layer is a transparent material for insulating the semi-reflecting layer 12 and the first electrode 131 and for insulating the semi-reflecting layer 12 and the third electrode 141. This configuration prevents the semi-reflecting layer 12 and the first and third electrodes 131 and 141 from direct contact that causes short circuit.

As shown in FIG. 2A, the first display area 13 comprises a first electrode 131, a first organic functional layer 132 and a second electrode 133. The first organic functional layer 132 is sandwiched between the first electrode 131 and the second electrode 133. The first electrode 131 is disposed on the semi-reflecting layer 12.

The first electrode 131 is disposed on the semi-reflecting layer 12 by a sputtering method or an ion plating method. The first electrode 131 is usually used as an anode and made of a transparent conductive metal oxide, such as indium-tin oxide (ITO), aluminum-zinc oxide (AZO), or indium-zinc oxide (IZO).

The first organic functional layer 132 usually contains a hole-injecting layer, a hole-transporting layer, an light-emitting layer, an electron-transporting layer, and an electron-injecting layer (not shown). The first organic functional layer 132 can be disposed on the first electrode 131 by utilizing evaporation, spin coating, ink jet printing, or printing. In addition, the light emitted from the first organic functional layer 132 can be blue, green, red, white, other monochromatic light, or a colorful light as a combination of monochromatic lights.

Referring to FIG. 2A again, the second electrode 133 is disposed on the first organic functional layer 132. Herein, the second electrode 133 can be formed on the first organic functional layer 132 by way of evaporation or sputtering. The material of the second electrode 133 can be aluminum, calcium, magnesium, indium, zinc, manganese, silver, gold, and magnesium alloy. The magnesium alloy can be, for example, Mg:Ag alloy, Mg:In alloy, Mg:Sn alloy, Mg:Sb alloy and Mg:Te alloy.

Please reference to FIG. 2A. The second display area 14 comprises a third electrode 141, a second organic functional layer 142 and a fourth electrode 143. The second organic functional layer 142 is sandwiched between the third electrode 141 and the fourth electrode 143. The third electrode 141 is disposed on the semi-reflecting layer 12.

Wherein the features and functions of the third electrode 141, second organic functional layer 142, and fourth electrode 143 are the same to the first electrode 131, first organic functional layer 132, and second electrode 133 described previously, so the detailed descriptions are omitted here for concise purpose.

Alternatively, the semi-reflecting layer 12 of the embodiment can also be disposed on the second surface 112 of the transparent substrate 11, as shown in FIG. 2B.

In the current embodiment, the thickness of the fourth electrode 143 is larger than that of the second electrode 133. With reference to FIGS. 2A and 2B, since the fourth electrode 143 is thicker, the light emitted from the second display area 14 is outputted toward the direction B. That is, the light emitted from the second display area 14 passes through the semi-reflecting layer 12 and the transparent substrate 11, because the light generated by the second organic functional layer 142 can pass through the semi-reflecting layer 12 easier (compared with the fourth electrode 143).

In addition, since the second electrode 133 is thinner, the light emitted from the first display area 13 is outputted toward the direction A. That is, the light emitted from the first display area 13 passes through the second electrode 133, because the light generated by the first organic functional layer 132 can pass through the second electrode 133 easier (compared with the semi-reflecting layer 12).

In this embodiment, when the semi-reflecting layer 12, for example but not limited to an aluminum metal layer with a thickness of 50 Å, has an optical transmittance about 50%, the fourth electrode 143 can be made of aluminum metal with a thickness of 100 Å, and the second electrode 133 can be made of aluminum metal with a thickness of 10 Å. In this case, as shown in FIGS. 2A and 2B, the first display area 13 emits light toward the direction A, and the second display area 14 emits light toward the direction B.

In the embodiment, the thicknesses of the second electrode 133 and the fourth electrode 143 can be adjusted according to the practical demands.

The configuration and the sizes of the first display area 13 and the second display area 14 can also be adjusted according to the practical demands.

In addition, the display device 1 of the embodiment may further comprise a cover plate 15, which is attached to the transparent substrate 11 or the semi-reflecting layer 12. Since the first display area 13 and the second display area 14, which are organic electroluminescent devices, are very sensitive to moisture and oxygen, dark spots may be formatted when the display areas contact with air. Thus, the cover plate 15 is applied to prevent the first display area 13 and the second display area 14 from being damaged by moisture and oxygen.

Moreover, the display device 1 of the embodiment my further comprise a drying unit 16, which is disposed between the cover plate 15 and the second electrode 133 and/or the fourth electrode 143. Herein, the drying unit 16 can be desiccants for desiccating the water contained in the first display area 13 and the second display area 14 after they are encapsulated. This can efficiently prolong the lifetime of the display device.

Furthermore, the display device 1 of the embodiment may further comprise a passivation layer 17, which disposes on the semi-reflecting layer 12, the first display layer 13 and the second display layer 14. Herein, the passivation layer 17 is to prevent the first display area 13 and the second display area 14 from being damaged by moisture and oxygen.

In addition, the display device 1 of the embodiment may further comprise a driving circuit (not shown), which is a passive driving circuit or an active driving circuit. The driving circuit couples to the first display area 13, the second display area 14, and a power (not shown).

In the embodiment, the first display area 13 and the second display area 14 are individually driven. In other words, the applied voltages for the first display area 13 and the second display area 14 may be different from one another according to practically demands. Herein, the first display area 13 can be used as a sub-display panel, which cooperates with the second display area 14 to increase the convenient of users. In this case, the first display area 13 and the second display area 14 may respectively display films and picture, such as numerals, according to the demands. Of course, the first display area 13 and the second display area 14 can be driven at the same time.

In addition, the display device 1 of the embodiment further comprises an image transform module (not shown), which controls the image orientation of the first display area 13 or the second display area 14. In other words, when the displayed image data of the first display area 13 is transmitted from the second display area 14, the image transform module may adjust the image orientation of the first display area 13 according to the image data from the second display area 14 based on the operation situation for facilitating users to view the image information. For example, the image data may be turned to the orientation directly facing the user.

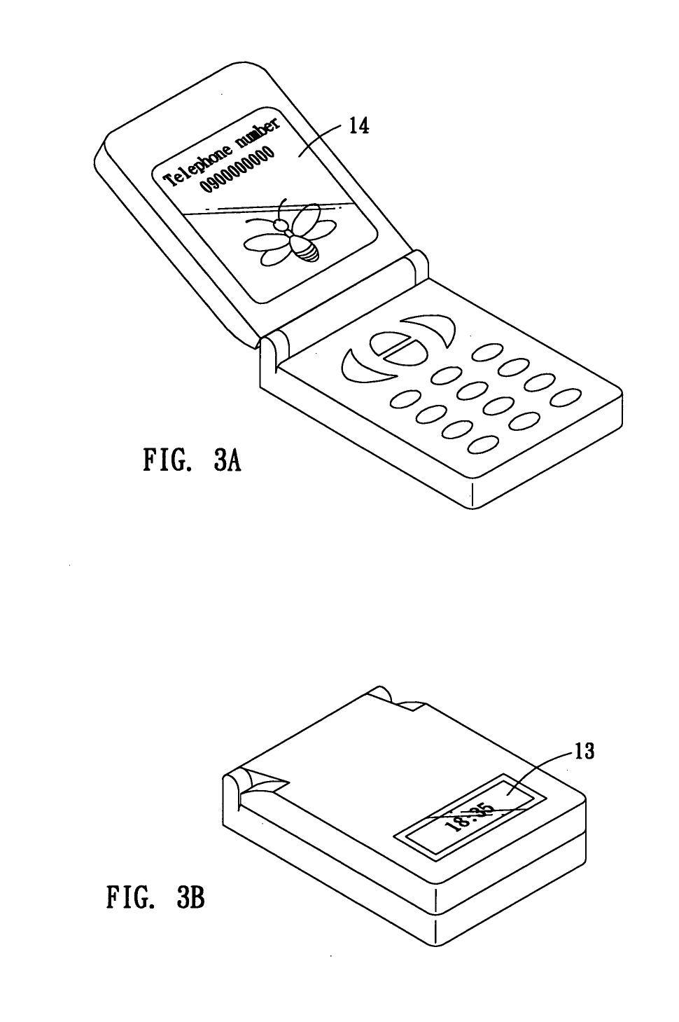

Hereinafter, an example is shown, wherein the display device is embodied in a mobile phone, referring to FIGS. 3A and 3B. Wherein, FIGS. 3A and 3B are schematic views showing an application of the display device shown in FIG. 2A.

As shown in FIG. 3A, when a user opens the mobile phone, the second display area 14 displays the telephone number of the caller and other relative information. In addition, as shown in FIG. 3B, when the user closes the mobile phone, the first display area 13 displays different information, such as the local time, from that displayed on the second display area 14. Of course, the first display area 13 may display the same information as that displayed on the second display area 14. In this case, the image information is firstly transmitted to the first display area 13. The image transform module detects the operation situation and then transforms the image of the first display area 13 to the orientation directly facing the user's eyes according to the detected results.

In the present embodiment, when the first display area 13 and the second display area 14 emit light, the user can see the displayed images of the first display area 13 and the second display area 14, such as words, numbers, pictures or images. On the other hand, when the first display area 13 and/or the second display area 14 do not emit light, the user can see the reflected image opposite to the display areas. That is, the first display area 13 or the second display area 14 is used as a mirror.

### Second Embodiment

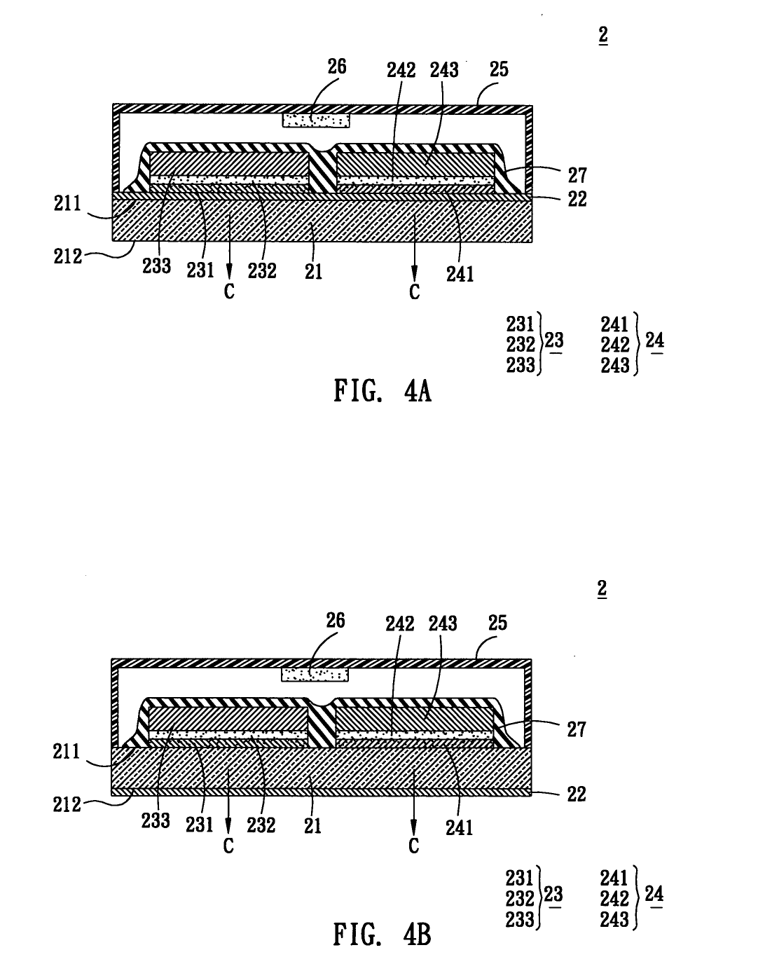

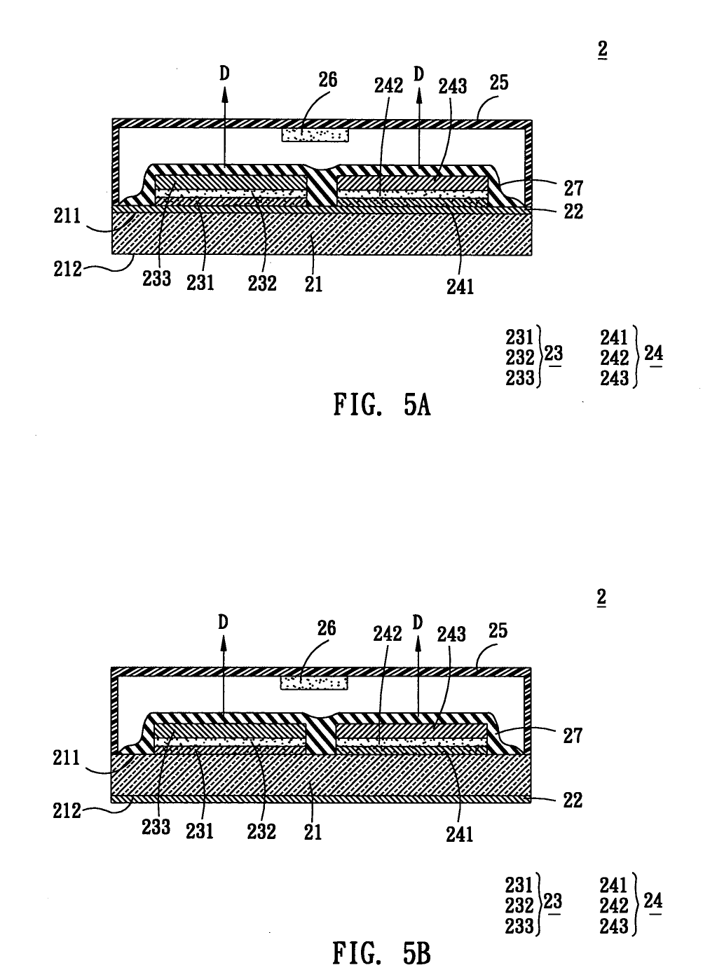

With reference to FIGS. 4A, 4B, 5A and 5B, a display device with dual display areas 2 according to the second embodiment of the invention comprises a transparent substrate 21, a semi-reflecting layer 22, a first display area 23 and a second display area 24. In the embodiment, the transparent substrate 21 has a first surface 211 and a second surface 212, which is opposite to the first surface 211. The semi-reflecting layer 22 is disposed on the first surface 211 or on the second surface 212. The first display area 23 comprises, in sequence, a first electrode 231, at least one first organic functional layer 232 and a second electrode 233. The first electrode 231 is disposed over the first surface 211 of the transparent substrate 21. The second display area 24 comprises, in sequence, a third electrode 241, at least one second organic functional layer 242 and a fourth electrode 243. The third electrode 241 is disposed over the first surface 211 of the transparent substrate 21.

In this embodiment, the features and functions of the transparent substrate 21, semi-reflecting layer 22, first electrode 231, first organic functional layer 232, third electrode 241, and second organic functional layer 242 are the same to those described in the first embodiment, so the detailed descriptions are omitted here for concise purpose.

As shown in FIGS. 4A and 4B, since the second electrode 233 and the fourth electrode 243 are thicker, the light emitted from the first display area 23 and the second display area 24 is outputted toward the direction C. That is, the light emitted from the first display area 23 and the second display area 24 passes through the semi-reflecting layer 22 and the transparent substrate 21, because the light generated by the first organic functional layer 232 and the second organic functional layer 242 can pass through the semi-reflecting layer 22 easier (compared with the second electrode 233 and the fourth electrode 243). When the semi-reflecting layer 22, for example but not limited to an aluminum metal layer with a thickness of 50 Å, has an optical transmittance about 50%, the second electrode 233 and the fourth electrode 243 can be made of aluminum metal with a thickness of 100 Å.

Alternatively, as shown in FIGS. 5A and 5B, since the second electrode 233 and the fourth electrode 243 are thinner, the light emitted from the first display area 23 and the second display area 24 is outputted toward the direction D. That is, the light emitted from the first display area 23 and the second display area 24 passes through the second electrode 233 and the fourth electrode 243, because the light generated by the first organic functional layer 232 and the second organic functional layer 242 can pass through the second electrode 233 and the fourth electrode 243 easier (compared with the semi-reflecting layer 22). When the semi-reflecting layer 22, for example but not limited to an aluminum metal layer with a thickness of 50 Å, has an optical transmittance about 50%, the second electrode 233 and the fourth electrode 243 can be made of aluminum metal with a thickness of 10 Å.

In the embodiment, the thicknesses of the second electrode 233 and the fourth electrode 243 can be adjusted according to the practical demands.

The configuration and the sizes of the first display area 23 and the second display area 24 can also be adjusted according to the practical demands.

Furthermore, the display device 2 of the embodiment may comprise a cover plate 25, a drying unit 26, a passivation layer 27, a driving circuit (not shown), and an image transform module (not shown). Those elements of the second embodiment are the same as those described in the first embodiment, so the detailed descriptions are omitted here for concise purpose.

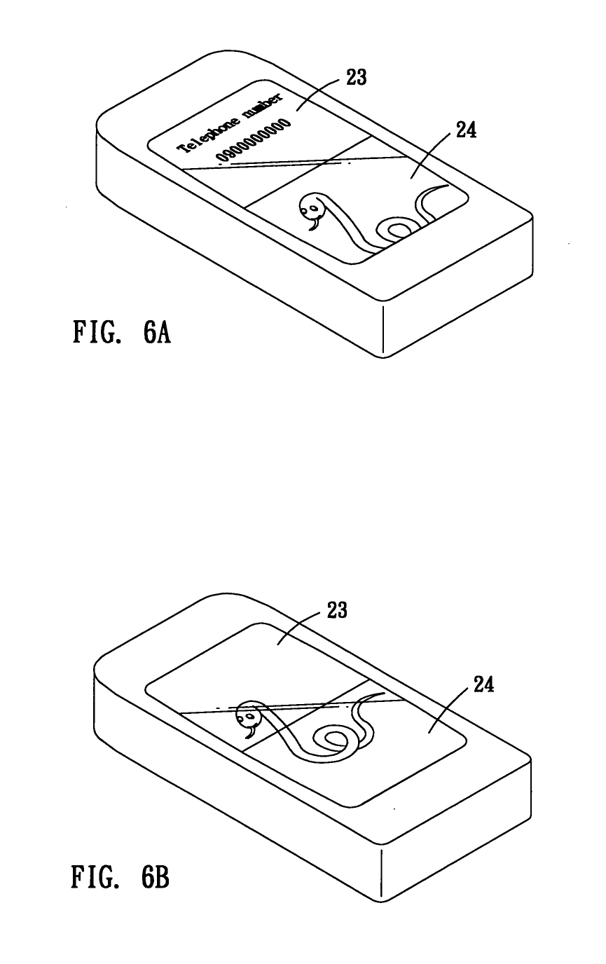

Hereinafter, an example is shown, wherein the display device is embodied in a mobile phone, with reference to FIGS. 6A and 6B. In this case, FIGS. 6A and 6B are schematic views showing an application of the display device shown in FIG. 5A. As shown in FIG. 6A, the first display area 23 and the second display area 24 are respectively display different image information. Of course, the first display area 23 may display the same information as that displayed on the second display area 24. In addition, as shown in FIG. 6B, the first display 23 and the second display area 24 can combine to present an extended screen. That is, the image information displayed on the first display area 23 and the second display area 24 can construct an integrated screen. Therefore, the limitation of the size of the original first display area 23 or second display area 24 can be overcome.

The display device with dual display areas of the invention has two display areas disposed on a single transparent substrate, and the directions of light emitted from the display areas can be controlled by the thicknesses of the semi-reflecting layer, the second electrode, and the fourth electrode. Comparing with the prior art, the display device with dual display areas of the invention saves one transparent substrate and one cover plate, so the thickness of the whole device is more compact and more lightweight. Moreover, since both the display areas can be formed in the same manufacturing processes, such as photolithograph processes and coating processes, the fabrication time can be shortened, the cost of the display device can be decreased, and the production yield can be increased. In addition, the two display areas can show different image information according to any requirement. Of course, the display areas can display the same image information. Furthermore, the two display areas may combine to present an extended screen, which can overcome the limitation of the size of a single display area. In the invention, when the display areas emit light, the display device possesses the function of displaying image; otherwise, when the display areas do not emit light, the display device possesses the function of mirror. In summary, the display device of the invention has not only the function of dual directions displaying but also the function of mirror. Moreover, the display device of the invention is compact and lightweight, and has the features of the manufacturing process integration and information division. Therefore, the invention is suitable for mass production.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device with dual display areas, comprising:
a transparent substrate, which has a first surface and a second surface opposite to the first surface;
a semi-reflecting layer, which is disposed on the first surface or on the second surface;
a first display area, which sequentially comprises a first electrode, at least one first organic functional layer and a second electrode, wherein the first electrode is disposed over the first surface of the transparent substrate; and
a second display area, which sequentially comprises a third electrode, at least one second organic functional layer and a fourth electrode, wherein the third electrode is disposed over the first surface of the transparent substrate, and the thickness of the fourth electrode is larger than the thickness of the second electrode.

2. The display device of claim 1, wherein the transparent substrate is at least one selected from the group consisting of rigid substrate, flexible substrate, glass substrate and plastic substrate.

3. The display device of claim 1, wherein the semi-reflecting layer comprises a metal or a dielectric material.

4. The display device of claim 1, wherein the semi-reflecting layer has an optical transmittance between about 10% and 90%.

5. The display device of claim 1, wherein the first electrode and the third electrode comprise conductive metal oxide.

6. The display device of claim 5, wherein the conductive metal oxide is at least one selected from the group consisting of indium-tin oxide (ITO), aluminum-zinc oxide (AZO) and indium-zinc oxide (IZO).

7. The display device of claim 1, wherein the second electrode and fourth electrode are made of at least one material selected from the group consisting of aluminum, calcium, magnesium, indium, zinc, manganese, silver, gold and magnesium alloy.

8. The display device of claim 1, further comprising:
a cover plate attached to the transparent substrate or the semi-reflecting layer with an adhesive.

9. The display device of claim 8, further comprising:
a drying unit disposed between the cover plate and the second electrode and/or the fourth electrode.

10. The display device of claim 1, further comprising:
a passivation layer disposed on the semi-reflecting layer, the first display area and the second display area.

11. The display device of claim 1, further comprising:
an image transform module, which controls the image orientation of the first display area or the second display area.

12. A display device with dual display areas, comprising:
a transparent substrate, which has a first surface and a second surface opposite to the first surface;
a semi-reflecting layer, which is disposed on the first surface or on the second surface;
a first display area, which sequentially comprises a first electrode, at least one first organic functional layer and a second electrode, wherein the first electrode is disposed over the first surface of the transparent substrate; and
a second display area, which sequentially comprises a third electrode, at least one second organic functional layer and a fourth electrode, wherein the third electrode is disposed over the first surface of the transparent substrate.

13. The display device of claim 12, wherein the semi-reflecting layer comprises a metal or a dielectric material.

14. The display device of claim 12, wherein the semi-reflecting layer has an optical transmittance between about 10% and 90%.

15. The display device of claim 12, wherein the first electrode and the third electrode comprise conductive metal oxide.

16. The display device of claim 12, wherein the second electrode and fourth electrode are made of at least one material selected from the group consisting of aluminum, calcium, magnesium, indium, zinc, manganese, silver, gold and magnesium alloy.

17. The display device of claim 12, further comprising:
a cover plate attached to the transparent substrate or the semi-reflecting layer with an adhesive.

18. The display device of claim 17, further comprising:
a drying unit disposed between the cover plate and the second electrode and/or the fourth electrode.

19. The display device of claim 12, further comprising:
a passivation layer disposed on the semi-reflecting layer, the first display area and the second display area.

20. The display device of claim 12, further comprising:
an image transform module, which controls the image orientation of the first display area or the second display area.
